(19) United States
(12) Patent Application Publication
(10) Pub. No.: US 2025/0300285 A1
(43) Pub. Date: Sep. 25, 2025

(54) BATTERY AND METHOD FOR MANUFACTURING BATTERY

(71) Applicant: MURATA MANUFACTURING CO., LTD., Kyoto (JP)

(72) Inventor: Masayuki KAGEYAMA, Kyoto (JP)

(21) Appl. No.: 19/034,782

(22) Filed: Jan. 23, 2025

(30) Foreign Application Priority Data
Mar. 22, 2024 (JP) 2024-046744

(51) Int. Cl. H01M 50/188; H01M 50/193; H01M 50/197

(52) U.S. Cl. CPC H01M 50/188; H01M 50/193; H01M 50/197

(57) ABSTRACT

A battery is provided and includes an electrode body including a positive electrode terminal and a negative electrode terminal; and an exterior member that houses the electrode body. The exterior member includes: a box member that has a metallic box shape including a first side part with a through hole; a plate member disposed inside the through hole to be separated from the first side part in a plan view from the first side part; and a sealing body including a resin layer in contact with each of a first contact surface of the first side part and a second contact surface of the plate member, the resin layer sealing a gap between the first side part and the plate member. Each of the first contact surface and the second contact surface has a plurality of recesses arranged in a matrix at a site overlapped with the resin layer in the plan view from the first side part. The recesses are filled with a part of the resin layer.

### CROSS REFERENCE TO RELATED APPLICATIONS

The present application claims priority to Japanese patent application no. 2024-046744, filed on Mar. 22, 2024, the entire contents of which are incorporated herein by reference.

### BACKGROUND

The present disclosure relates to a battery and a method for manufacturing the battery.

A method for manufacturing a metal component is disclosed that is joined to a resin component, and a composite molded body including the metal component manufactured in accordance with the manufacturing method and the resin component. In accordance with the manufacturing method, a plurality of rough surfaces are formed with a laser so as to be arranged at a joint surface of the metal component to which the resin component is joined. The close contact property between the resin part and the metal part is improved by adjusting the interval between the adjacent rough surfaces and the depths of irregularities formed at the rough surfaces.

### SUMMARY

The present disclosure relates to a battery and a method for manufacturing the battery.

It is conceivable that the composite molded body as described in the Background section is applied to an exterior member of a battery. In the exterior member of the battery, it is conceivable that the metal component and the resin component are peeled from each other depending on an increase in the internal pressure of the exterior member. In this case, there is a desire for simply adjusting the joint strength between the metal component and the resin component depending on the type and size of an electrode body in the exterior member.

The present disclosure, in an embodiment, relates to providing a battery in which the joint strength between a metal member and a resin member can be simply adjusted, and a method for manufacturing the battery.

A battery according to the present disclosure, in an embodiment, includes: an electrode body including a positive electrode terminal and a negative electrode terminal; and an exterior member that houses the electrode body, the exterior member includes: a box member that has a metallic box shape including a side plate part with a through hole, houses the electrode body, and is electrically connected to the negative electrode terminal; a plate member disposed inside the through hole to be separated from the side plate part in a plan view from the side plate part, and electrically connected to the positive electrode terminal; and a sealing body including a resin layer in contact with each of a first contact surface of the side plate part and a second contact surface of the plate member, the sealing body sealing a gap between the side plate part and the plate member, each of the first contact surface and the second contact surface has a plurality of recesses arranged in a matrix at a site overlapped with the resin layer in the plan view from the side plate part, and the recesses are filled with a part of the resin layer.

A method for manufacturing a battery according to the present disclosure, in an embodiment, includes: a box member that has a box shape including a side plate part and houses an electrode body; a plate member disposed inside a through hole of the side plate part to be separated from the side plate part; and a sealing body in contact with each of the side plate part and the plate member, the sealing body sealing a gap between the side plate part and the plate member, and the method includes: a first step of determining a plurality of irradiation positions at which a site overlapped with the sealing body in a plan view from the side plate part is irradiated with a laser at each of a first contact surface of the side plate part in contact with the sealing body and a second contact surface of the plate member in contact with the sealing body, and determining an intensity of the laser; a second step of forming a plurality of recesses such that the recesses are arranged in a matrix in the plan view from the side plate part, by irradiating the site with the laser at the intensity of the laser determined in the first step at each of the plurality of irradiation positions determined in the first step; and a third step of joining the side plate part and the plate member to the sealing body, by performing thermal welding with the side plate part and the plate member in contact with the sealing body such that a part of the sealing body enters the recesses.

The battery and the method for manufacturing a battery according to the present disclosure, in an embodiment, allows the joint strength between the metal member and the resin member to be simply adjusted.

### BRIEF DESCRIPTION OF THE FIGURES

FIG. 1 is a perspective view of a battery according to an embodiment of the present disclosure;

FIG. 2 is an exploded perspective view of the battery shown in FIG. 1;

FIG. 3 is a sectional view of the battery shown in FIG. 1;

FIG. 4 is a diagram illustrating a plan view of the battery viewed from a first side part;

FIG. 5 is an enlarged sectional view of a part of the sealing body shown in FIG. 3;

FIG. 6 is a plan view of a site of a first contact surface and a second contact surface;

FIG. 7 is a sectional view of a recess along the line VII-VII shown in FIG. 6;

FIG. 8 is a graph showing joint strength; and

FIG. 9 is an exploded perspective view of a battery according to a modification example of an embodiment of the present disclosure.

### DETAILED DESCRIPTION

The present disclosure will be described in further detail including with reference to the drawings according to an embodiment. It is to be noted that the present disclosure is not limited by the embodiments. Each of the embodiments is illustrative, and obviously, parts of the configurations illustrated in the different embodiments can be replaced or combined with each other.

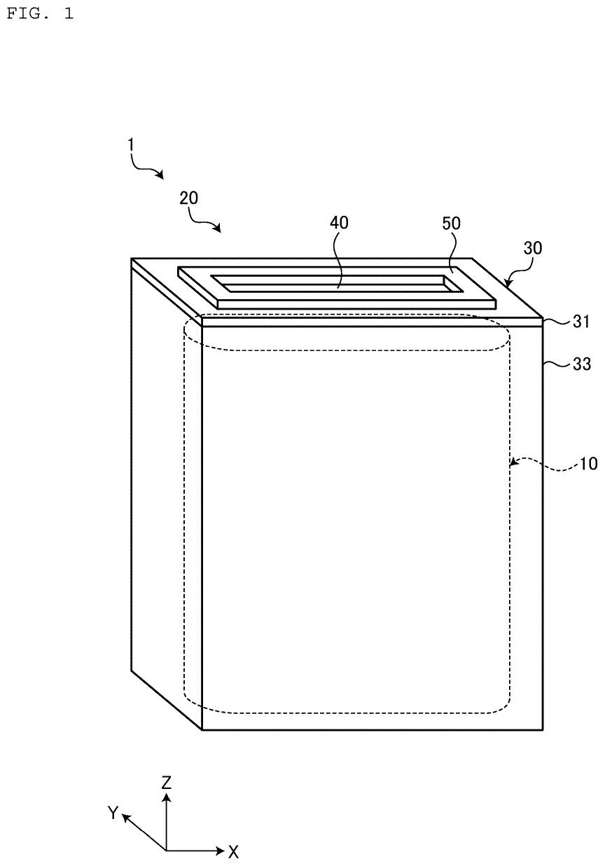

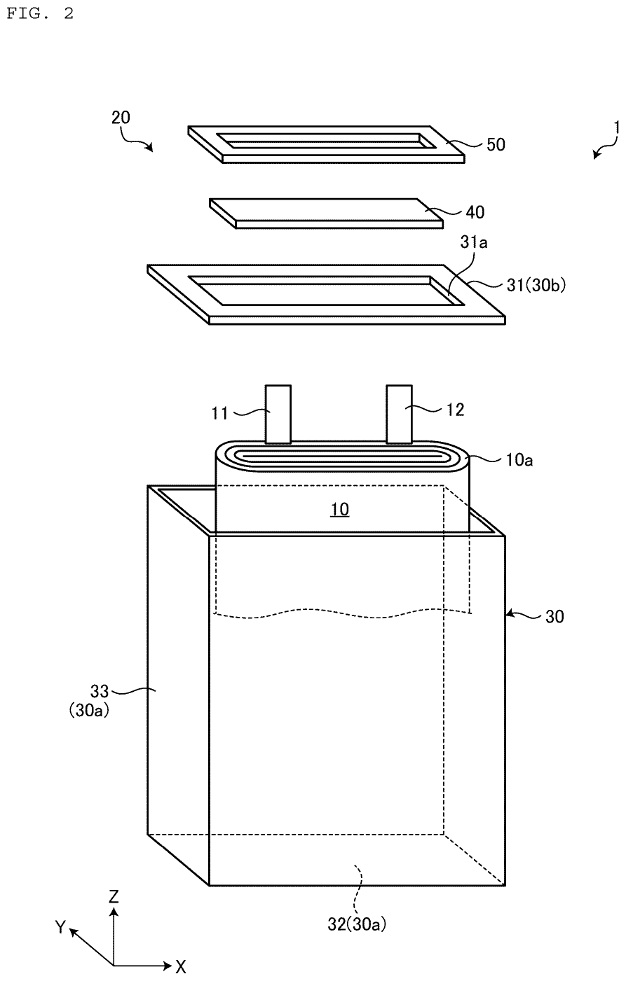

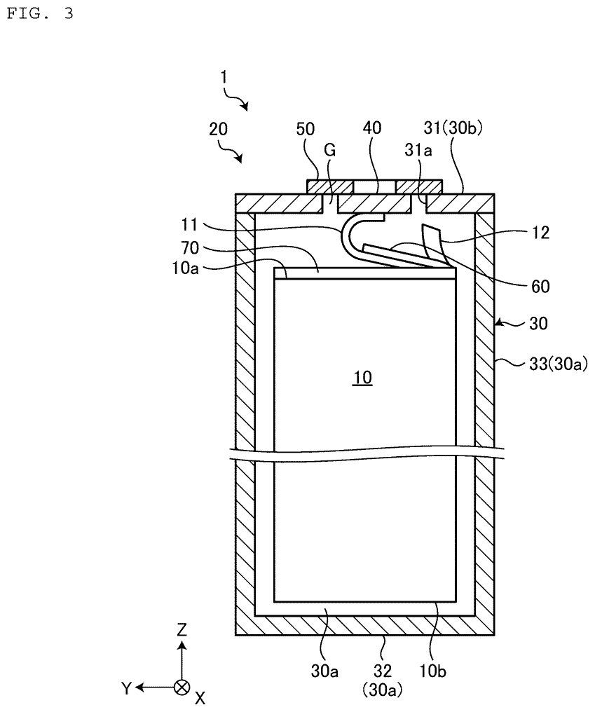

FIG. 1 is a perspective view of a battery 1 according to an embodiment of the present disclosure. FIG. 2 is an exploded perspective view of the battery 1 shown in FIG. 1. FIG. 3 is a sectional view of the battery 1 shown in FIG. 1. The X direction, Y direction, and Z direction shown in the drawings are orthogonal to each other, and correspond respectively to the width direction, depth direction, and height direction of the battery 1. Obviously, the X direction, the Y direction, and the Z direction are not limited to the directions shown in the drawings.

The battery 1 is a secondary battery. The battery 1 is, for example, a lithium battery. The battery 1 includes an electrode body 10 and an exterior member 20.

The electrode body 10 is a wound-type electrode body. The electrode body 10 is formed by stacking and winding elongated positive electrode and negative electrode with a separator interposed therebetween. The electrode body 10 has a flattened shape. The electrode body 10 has a first end surface 10a and a second end surface 10b that face opposite sides in the Z direction.

The electrode body 10 includes a strip-shaped positive electrode terminal 11 electrically connected to the positive electrode and a strip-shaped negative electrode terminal 12 electrically connected to the negative electrode. The positive electrode terminal 11 and the negative electrode terminal 12 are located on the first end surface 10a of the electrode body 10.

The exterior member 20 includes a box member 30, a plate member 40, and a sealing body 50.

The box member 30 has a metallic box shape that houses the electrode body 10. The box member 30 has conductivity. The material of the box member 30 is, for example, Fe (iron), Cu (copper), Ni (nickel), stainless steel, an iron alloy, a copper alloy, a nickel alloy, or the like. The type of stainless steel is not particularly limited, and specific examples thereof include SUS304 and SUS316.

The box member 30 has a rectangular parallelepiped shape that has a first side part 31 (corresponding to the “side plate part”), a second side part 32, and third side parts 33.

The first side part 31 has a flat plate shape that faces the first end surface 10a of the electrode body 10 and has a through hole 31a. The second side part 32 has a flat plate shape located across the electrode body 10 from the first side part 31. The second side part 32 faces the second end surface 10b. The first side part 31 and the second side part 32 face each other with the electrode body 10 interposed therebetween in the Z direction. Each of the third side parts 33 connects the first side part 31 and the second side part 32. The third side part 33 has a rectangular section.

In addition, the second side part 32 and the third side parts 33, which are integrated, constitute a housing part 30a with a cavity. In the hosing part 30a, the second side part 32 corresponds to a bottom plate, and the third side parts 33 correspond to side plates.

The first side part 31 constitutes a lid 30b that covers the cavity of the housing part 30a. The peripheral edge of the lid 30b is joined by, for example, laser welding to the peripheral edge of the cavity of the housing part 30a over the whole perimeter. Thus, the housing part 30a and the lid 30b are electrically connected, and the housing part 30a and the lid 30b are sealed therebetween.

The negative electrode terminal 12 is joined by, for example, resistance welding to the inner surface of the housing part 30a (the inner surface of the third side part 33). Thus, the housing part 30a is electrically connected to the negative electrode terminal 12. More specifically, the box member 30 is electrically connected to the negative electrode terminal 12.

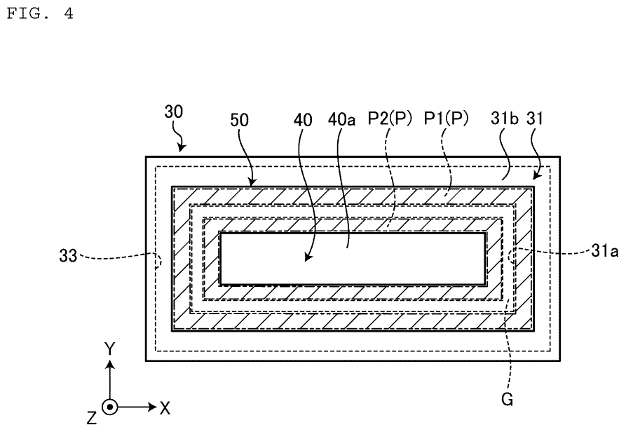

FIG. 4 is a diagram illustrating a plan view of the battery 1 viewed from the first side part 31.

The plate member 40 shown in FIGS. 1, 2, 3, and 4 has a flat plate shape and has conductivity. The thickness of the plate member 40 is substantially equal to the thickness of the first side part 31. The material of the plate member 40 is aluminum, an aluminum alloy, or the like. In addition, the material of the plate member 40 may be, for example, a clad material obtained by rolling and joining: a metal layer made of one or more of Fe (iron), Cu (copper), Ni (nickel), stainless steel, an iron alloy, a copper alloy, and a nickel alloy; and an aluminum layer. Furthermore, for example, a composite member that has a three-layer structure of an Al (aluminum) layer, a stainless steel layer, and a nickel layer may be applied to the plate member 40. The type of stainless steel is not particularly limited, and for example, SUS304, SUS316, and the like.

The plate member 40 is disposed inside the through hole 31a to be separated from the first side part 31 in a plan view from the first side part 31. The plate member 40 faces the first end surface 10a of the electrode body 10. The plan view from the first side part 31 has a gap G between the first side part 31 and the plate member 40 over the whole perimeter of the peripheral edge of the plate member 40. The plate member 40 is electrically insulated from the box member 30 by the gap G.

As shown in FIG. 3, the positive electrode terminal 11 is joined by, for example, laser welding to the inner surface of the plate member 40. Thus, the plate member 40 is electrically connected to the positive electrode terminal 11.

In addition, the battery 1 further includes a first insulator 60 and a second insulator 70. The first insulator 60, which has a strip shape, is disposed on the positive electrode terminal 11. The first insulator 60 electrically insulates the positive electrode terminal 11 from the box member 30. The second insulator 70 is disposed on the first end surface 10a of the electrode body 10. The second insulator 70 electrically insulates the positive electrode terminal 11 from the negative electrode.

The sealing body 50 is located outside the exterior member 20 relative to the first side part 31 and the plate member 40. The sealing body 50 seals the gap G between the first side part 31 and the plate member 40. The sealing body 50 has an annular shape in a plan view. The plate member 40 is exposed from the inside of the sealing body 50. The sealing body 50 is overlapped with the first side part 31, the plate member 40, and the gap G in a plan view from the first side part 31.

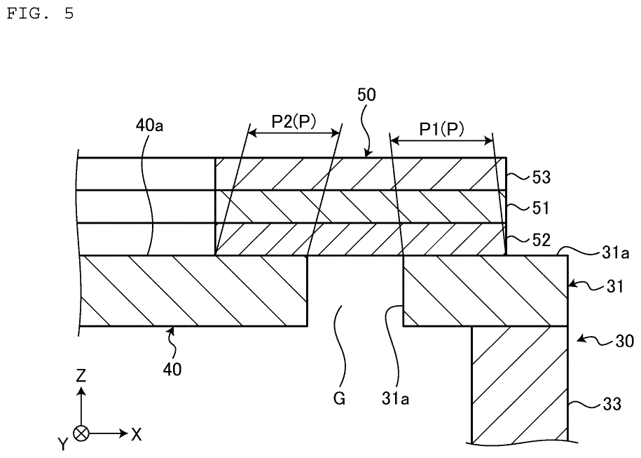

FIG. 5 is an enlarged sectional view of a part of the sealing body 50 shown in FIG. 3. The sealing body 50 includes a substrate layer 51, a resin layer 52, and a protective layer 53.

The material of the substrate layer 51 is, for example, stainless steel. The type of stainless steel is not particularly limited, and specific examples thereof include SUS304 and SUS316. In addition, the material of the substrate layer 51 may be, for example, a simple metal such as aluminum, iron, copper, and nickel, and alloys thereof, that is, an aluminum alloy, an iron alloy, a copper alloy, a nickel alloy, and the like.

The resin layer 52 is overlapped with the substrate layer 51, in contact with the first side part 31 and the plate member 40. The resin layer 52 seals the gap G. The material of the resin layer 52 is a thermoplastic resin that has an electrical insulation property. The material of the resin layer 52 is, for example, polypropylene (PP), polyethylene (PE), or the like. The material of the resin layer 52 may be unstretched polypropylene (CPP), polyphenylene sulfide (PPS), or the like.

The protective layer 53 is overlapped with the substrate layer 51 on the side opposite to the resin layer 52 to protect the substrate layer 51. The protective layer 53 has an electrical insulation property. The heat resistance of the protective layer 53 is higher than the heat resistance of the resin layer 52. The material of the protective layer 53 is a thermoplastic resin. The material of the protective layer 53 is, for example, nylon, polyethylene terephthalate (PET), or the like.

The sealing body 50 is joined by thermal welding to the first side part 31 and the plate member 40. As shown in FIGS. 4 and 5, with the resin layer 52 in contact with each of a first contact surface 31b of the first side part 31 and a second contact surface 40a of the plate member 40, the resin layer 52 is joined to each of the first side part 31 and the plate member 40.

The first contact surface 31b is an outward facing surface of the first side part 31, and has a first site P1 (corresponding to the “site”) overlapped with the sealing body 50 in a plan view from the first side part 31. The first site P1 extends over the whole perimeter of the through hole 31a at the first contact surface 31b.

The second contact surface 40a is an outward facing surface of the plate member 40, and has a second site P2 (corresponding to the “site”) overlapped with the sealing body 50 in a plan view from the first side part 31. The second site P2 extends over the whole perimeter of the peripheral edge of the second contact surface 40a. Hereinafter, when the first site P1 and the second site P2 are described without distinction, the both will be referred to as a site P.

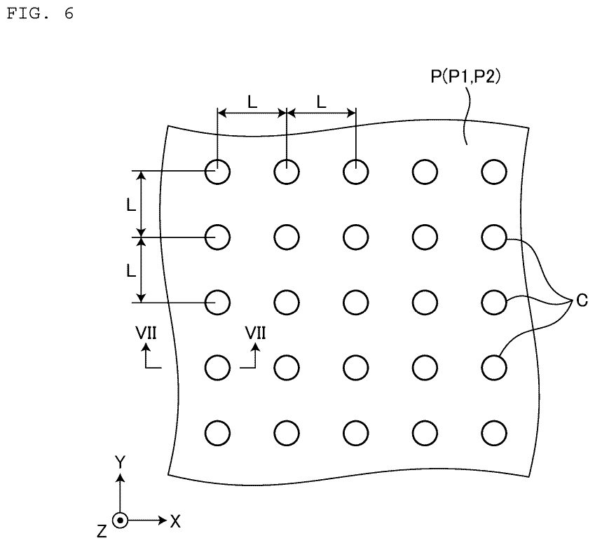

FIG. 6 is a plan view of the site P of the first contact surface 31b and second contact surface 40a.

The site P has a plurality of recesses C arranged in a matrix. The row direction is along the X direction. The column direction is along the Y direction. The plurality of recesses C is arranged at equal intervals in the row direction and the column direction.

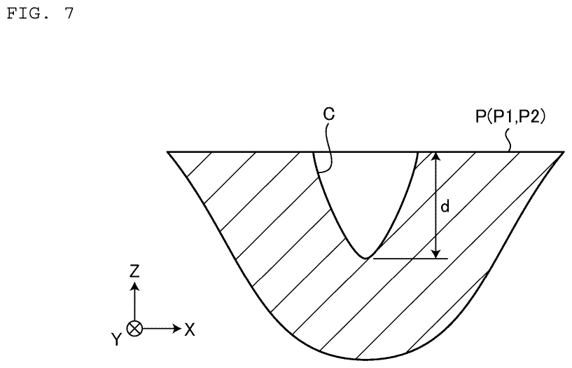

FIG. 7 is a sectional view of the recess C along the line VII-VII shown in FIG. 6.

As for the recess C, the recess C has a width from the opening in the site P toward the bottom. The inner side surface of the recess C is, for example, a conical surface. The recesses C are filled with a part of the resin layer 52. Thus, an anchor effect of improved joint strength is produced between each of the first side part 31 and plate member 40 and the resin layer 52. The joint strength between the first side part 31 and plate member 40 and the sealing body 50 is smaller than the joint strength between the housing part 30a and the lid 30b in the box member 30.

In addition, when the internal pressure of the exterior member 20 is a predetermined pressure, cleavage is caused between the first contact surface 31b of the first side part 31 and the sealing body 50. More specifically, the sealing body 50 functions as a cleavage valve. The predetermined pressure is equal to or higher than the joint strength between the first contact surface 31b of the first side part 31 and the sealing body 50.

For example, when the positive electrode and the negative electrode are short-circuited in the electrode body 10, gas is generated from the electrode body 10, and the electrode body 10 abnormally generates heat. Thus, the resin layer 52 is softened, and when the internal pressure of the exterior member 20 reaches the predetermined pressure, the resin layer 52 is cleaved, and the gas leaks from the gap G. Accordingly, the internal pressure of the exterior member 20 is kept from being increased, and the safety of the battery 1 is secured.

The predetermined pressure is determined to be a pressure at which the safety of battery 1 can be ensured. The pressure at which the safety of the battery 1 can be ensured varies depending on, for example, a material of a member constituting the electrode body 10. Accordingly, the joint strength between each of the first side part 31 and plate member 40 and the resin layer 52 needs to be adjusted with the member of the electrode body 10 or the like.

In addition, the joint strength per unit area between each of the first side part 31 and plate member 40 and the resin layer 52 needs to be adjusted with the area of the site P. Specifically, when the area of the site P is relatively small due to the relatively small size of the battery 1, the joint strength per unit area between each of the first side part 31 and plate member 40 and the resin layer 52 needs to be increased.

Accordingly, the depth of the recess C and the arrangement of the recesses C are determined for adjusting the joint strength between each of the first side part 31 and plate member 40 and the resin layer 52 (hereinafter, referred to as joint strength) to be an appropriate joint strength.

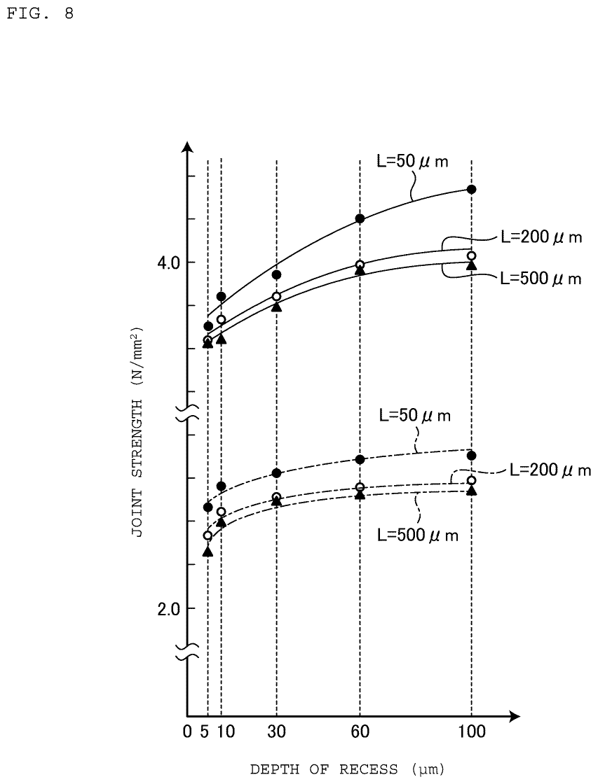

FIG. 8 is a graph showing the joint strength. The horizontal axis in FIG. 8 represents the depth (“d” shown in FIG. 7) of the recess C. In FIG. 8, the vertical axis represents the joint strength. The joint strength in FIG. 8 corresponds to a pressing force per unit area when the plate member 40 is pressed from the inside of the box member 30 to cleave the resin layer 52. The joint strength is calculated by dividing the pressing force to the plate member 40 on the cleavage of the resin layer 52, by the area of the site P.

Dots indicated by black circles, white circles, and black triangles In FIG. 8 indicate results of actually measuring the joint strength. The depths (d) of the recesses C in the actual measurement of the joint strength are 5 μm, 30 μm, 60 μm, and 100 μm.

In addition, the dots indicated by the black circles in FIG. 8 indicate a case where the interval (“L” in FIG. 6) between two recesses C adjacent to each other is 50 μm in each of the row direction and the column direction. The dots indicated by the white circles in FIG. 8 indicate a case where the interval (L) between the two recesses C is 200 μm. The dots indicated by the black triangles in FIG. 8 indicate a case where the interval (L) between the two recesses C is 500 μm.

Furthermore, the curves of solid lines and alternate long and short dash lines shown in FIG. 8 are approximate curves that show the relationship between the depth (d) of the recess C and the joint strength in a case where the interval (L) between the two recesses C is adjusted to three: 50 μm, 200 μm, and 500 μm.

In addition, the solid curves shown in FIG. 8 indicate a case where the material of the plate member 40 is SUS304 and the second contact surface 40a is nickel-plated. The curves of alternate long and short dash lines shown in FIG. 8 indicate a case where the material of the plate member 40 is aluminum. Further, the curves of solid lines and alternate long and short dash lines shown in FIG. 8 indicate a case where the material of the box member 30 is SUS316.

As shown in FIG. 8, for each of the two materials of the plate member 40, when the depth (d) of the recess C is 5 um or more and 100 μm or less, the joint strength is increased as the depth (d) of the recess C is increased. In addition, for each of the two materials of the plate member 40, when the interval (L) between the two recesses C is 50 μm or more and 500 μm or less, the joint strength is increased as the interval (L) between the two recesses C is decreased. More specifically, the joint strength between the metal member (the box member 30 and the plate member 40) and the resin member (the resin layer 52 of the sealing body 50) can be simply adjusted with the depth of the recess C and the arrangement of the recesses C.

Next, a method for forming the recesses C and a method for joining the box member 30 and the plate member 40 to the sealing body 50 will be described in a method for manufacturing the battery 1.

The plurality of recesses C is formed by irradiating the site P with a laser. First, a plurality of irradiation positions for irradiating the site P with the laser and the intensity of the laser are determined in a first step. The plurality of irradiation positions corresponds to the positions of the plurality of recesses C shown in FIG. 6. More specifically, the interval (L) between the two recesses C adjacent to each other in each of the row direction and the column direction is determined in the first step. The plurality of irradiation positions is determined based on the joint strength. The joint strength is determined based on the above-mentioned predetermined pressure (the internal pressure of the exterior member 20 on the cleavage of the sealing body 50), the area of the site P, and the like.

The intensity of the laser corresponds to the depth (d) of the recess C shown in FIG. 7. As the laser intensity is increased, the depth (d) of the recess C is increased. The intensity of the laser is determined based on the joint strength.

Subsequently, in a second step, the site P is irradiated with the laser at the laser intensity determined in the first step at each of the plurality of irradiation positions determined in the first step. Thus, as shown in FIG. 6, the plurality of recesses C is formed in the site P so as to be arranged in a matrix.

Furthermore, in a third step, the first side part 31 and the plate member 40 are joined to the sealing body 50. As mentioned above, with the first contact surface 31b of the first side part 31 and the second contact surface 40a of the plate member 40 in contact with the resin layer 52 of the sealing body 50, the first side part 31 and the plate member 40 as well as the sealing body 50 are sandwiched by a jig or the like and subjected to thermal welding. The thermal welding causes the resin layer 52 to be melted, and a part of the resin layer 52 enters the recesses C as shown in FIG. 7.

As mentioned above, the sealing body 50 is located outside the exterior member 20 relative to the first side part 31 and the plate member 40. Thus, the first contact surface 31b and the second contact surface 40a are located coplanar with each other, with the first side part 31 and the plate member 40 as well as the sealing body 50 sandwiched by the jig or the like for thermal welding, and the first side part 31 and the plate member 40 as well as the sealing body 50 can be easily subjected to thermal welding. In addition, the inner side surface of the recess C has a conical surface as mentioned above, and a part of the resin layer 52 easily enters the recesses C. Accordingly, the first side part 31 and the plate member 40 as well as the sealing body 50 can be reliably subjected to thermal welding, and the joint strength of the resin layer 52 can be stabilized.

It is to be noted that the embodiments mentioned above are intended to facilitate understanding of the present disclosure, but not intended to construe the present disclosure in any limited way. The present disclosure may be modified or improved without departing from the spirit of the present disclosure, and the present disclosure includes equivalents of the present disclosure.

For example, the electrode body 10 may be a rectangular parallelepiped staked body that has a plurality of sheet-shaped positive electrodes and a plurality of sheet-shaped negative electrodes alternately stacked with separators interposed therebetween.

The through hole 31a may be provided in the third side part 33.

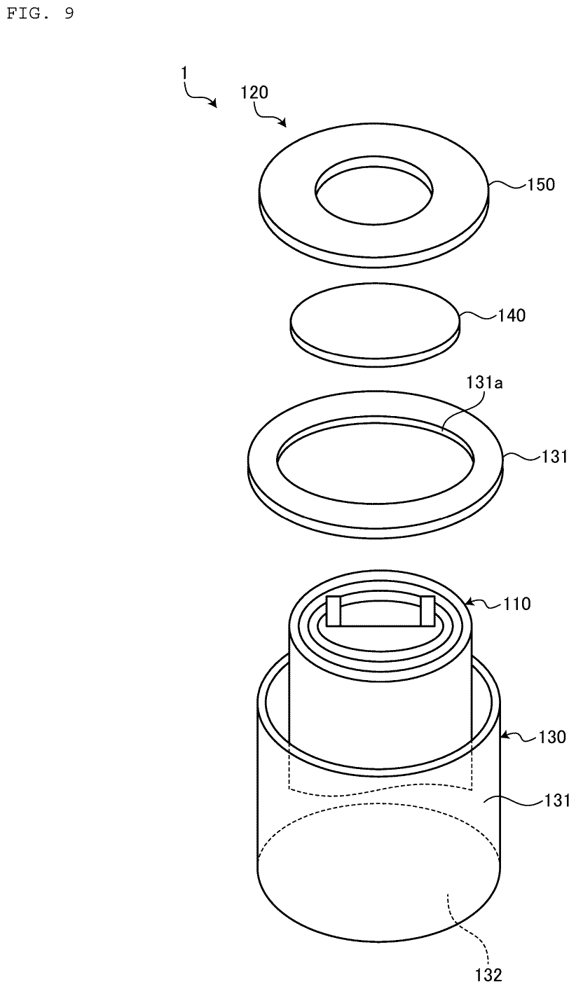

FIG. 9 is an exploded perspective view of the battery 1 according to a modification example of the embodiment of the present disclosure. In the present modification example, an exterior member 120 has a cylindrical shape. Specifically, a box member 130 has a cylindrical shape, and a third side part 133 has a tubular shape. A first side part 131, a second side part 132, and a plate member 140 each have a disk shape. The peripheral edge of a through hole 131a is circular. A sealing body 150 has a circular ring shape. In addition, in the present modification, an electrode body 110 has a cylindrical shape.

It is to be noted that the present disclosure may be a combination of the following configurations according to an embodiment.
(1)
A battery including:
an electrode body including a positive electrode terminal and a negative electrode terminal; and
an exterior member that houses the electrode body,
in which the exterior member includes:
a box member that has a metallic box shape including a side plate part with a through hole, houses the electrode body, and is electrically connected to the negative electrode terminal;
a plate member disposed inside the through hole to be separated from the side plate part in a plan view from the side plate part, and electrically connected to the positive electrode terminal; and
a sealing body including a resin layer in contact with each of a first contact surface of the side plate part and a second contact surface of the plate member, the sealing body sealing a gap between the side plate part and the plate member,
each of the first contact surface and the second contact surface has a plurality of recesses arranged in a matrix at a site overlapped with the resin layer in the plan view from the side plate part, and
the recesses are filled with a part of the resin layer.
(2)
The battery according to (1), in which each of the recesses has a width decreased from an opening of the recess toward a bottom thereof.
(3)
The battery according to (1) or (2), in which
the sealing body further includes:
a substrate layer overlapped with the resin layer; and
a protective layer overlapped with the substrate layer on a side opposite to the resin layer.
(4)
The battery according to any one of (1) to (3), in which the sealing body is located outside the exterior member relative to the side plate part and the plate member.
(5)
The battery according to any one of (1) to (4), in which when an internal pressure of the exterior member is a predetermined pressure that is equal to or higher than a joint strength between the first contact surface of the side plate part and the sealing body, the exterior member is cleaved between the first contact surface of the side plate part and the sealing body.
(6)
A method for manufacturing a battery including: a box member that has a box shape including a side plate part and houses an electrode body; a plate member disposed inside a through hole of the side plate part to be separated from the side plate part; and a sealing body in contact with each of the side plate part and the plate member, the sealing body sealing a gap between the side plate part and the plate member, the method including:
a first step of determining a plurality of irradiation positions at which a site overlapped with the sealing body in a plan view from the side plate part is irradiated with a laser at each of a first contact surface of the side plate part in contact with the sealing body and a second contact surface of the plate member in contact with the sealing body, and determining an intensity of the laser;
a second step of forming a plurality of recesses such that the recesses are arranged in a matrix in the plan view from the side plate part, by irradiating the site with the laser at the intensity of the laser determined in the first step at each of the plurality of irradiation positions determined in the first step; and
a third step of joining the side plate part and the plate member to the sealing body, by performing thermal welding with the side plate part and the plate member in contact with the sealing body such that a part of the sealing body enters the recesses.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
an electrode body including a positive electrode terminal and a negative electrode terminal; and
an exterior member that houses the electrode body,
wherein the exterior member includes:
a box member that has a metallic box shape including a side plate part with a through hole, houses the electrode body, and is electrically connected to the negative electrode terminal;
a plate member disposed inside the through hole to be separated from the side plate part in a plan view from the side plate part, and electrically connected to the positive electrode terminal; and
a sealing body including a resin layer in contact with each of a first contact surface of the side plate part and a second contact surface of the plate member, the sealing body sealing a gap between the side plate part and the plate member,
each of the first contact surface and the second contact surface has a plurality of recesses arranged in a matrix at a site overlapped with the resin layer in the plan view from the side plate part, and
the recesses are filled with a part of the resin layer.

2. The battery according to claim 1, wherein each of the recesses has a width decreased from an opening of the recess toward a bottom thereof.

3. The battery according to claim 1, wherein
the sealing body further includes:
a substrate layer overlapped with the resin layer; and
a protective layer overlapped with the substrate layer on a side opposite to the resin layer.

4. The battery according to claim 1, wherein the sealing body is located outside the exterior member relative to the side plate part and the plate member.

5. The battery according to claim 1, wherein when an internal pressure of the exterior member is a predetermined pressure that is equal to or higher than a joint strength between the first contact surface of the side plate part and the sealing body, the exterior member is cleaved between the first contact surface of the side plate part and the sealing body.

6. A method for manufacturing a battery including: a box member that has a box shape including a side plate part and houses an electrode body; a plate member disposed inside a through hole of the side plate part to be separated from the side plate part; and a sealing body in contact with each of the side plate part and the plate member, the sealing body sealing a gap between the side plate part and the plate member, the method comprising:
determining a plurality of irradiation positions at which a site overlapped with the sealing body in a plan view from the side plate part is irradiated with a laser at each of a first contact surface of the side plate part in contact with the sealing body and a second contact surface of the plate member in contact with the sealing body, and determining an intensity of the laser;
forming a plurality of recesses such that the recesses are arranged in a matrix in the plan view from the side plate part, by irradiating the site with the laser at the intensity of the laser determined in the first step at each of the plurality of irradiation positions; and
joining the side plate part and the plate member to the sealing body, by performing thermal welding with the side plate part and the plate member in contact with the sealing body such that a part of the sealing body enters the recesses.
